(19) United States
(12) Patent Application Publication
(10) Pub. No.: US 2008/0153417 A1
(43) Pub. Date: Jun. 26, 2008

(54) SYSTEM FOR SENSING ALARMS EXTERNAL TO A WIRELESS SHORT RANGE RF NETWORK AND FOR TRANSMITTING SUCH ALARMS TO TRANSCEIVING DEVICES WITHIN THE RF NETWORK

(76) Inventors: Dharmesh Bhakta, Austin, TX (US); Altaf Faheem, Pflugerville, TX (US); Kumar Ravi, Cedar Park, TX (US); Eric S. Rybczynski, Round Rock, TX (US)

Correspondence Address: IBM CORPORATION;INTELLECTUAL PROPERTY LAW, 11400 BURNET ROAD, AUSTIN, TX, 78758, US

(21) Appl. No.: 11/613,214

(22) Filed: Dec. 20, 2006

(51) Int. Cl. H04B 7/00

(52) U.S. Cl. 455/41.2

(57) ABSTRACT

Short range RF networks for transmitting to a plurality of wireless RF transceiving devices within a defined area. The wireless devices within the defined area each include a short range RF device transceiver enabling the device to wirelessly communicate with a data processor controlled wireless transmission system within said defined area, including a centrally located short range RF system transceiver for transmitting accessed data to the wireless devices. The central system transceiver should have an RF transmission range covering the defined area. An RF channel(s) is set to be used only for alarms. Then if an external alarm is sensed, all transmissions along other channels in the transmission area may be overridden, and the alarm data broadcast over the dedicated channel to all operational wireless devices within the area.

### TECHNICAL FIELD

The present invention relates to short range RF telecommunications and particularly to communication with wireless transceiving personal devices in RF networks that are likely to be used with user ear masking outputs, such as headphones or ear pieces.

### BACKGROUND OF RELATED ART

The past generation has been marked by a technological revolution driven by the convergence of the data processing industry with the consumer electronics industry. The effect has, in turn, driven miniaturized consumer electronics technologies into great demand in the marketplace.

The rapid expansion in the capacity of computers to perform support functions, the greater and greater miniaturization of computers, as well as reduction in costs to perform computer operations, has opened the door for computer controlled consumer instrumentation. This has resulted in a new generation of computer or data processor controlled audio-visual devices that are miniaturized and personalized to the user. Such devices include Personal Digital Assistants (PDAs), cellular/wireless telephones and palm-type computers. The original wireless personal devices were implemented through cellular telephone technology involving direct relatively short range communication between the personal cellular telephone and a cellular tower in a an expansive global network of such towers.

However, in recent years, wireless personal communication has been even more rapidly advanced through the expansion of wireless facilities. We have now reached the point that in addition to most major educational, business, technical and marketing facilities, even many hotels and restaurants have been set up to provide to personal wireless device users within the facility communication outlets to the Internet, telephone networks, as well as radio/television and cable network broadcasts. In the electronic entertainment technology, wireless MP3 music players are very extensively used. The wireless MP3 player is wirelessly connected to the Internet or Web through a base station that includes a short range RF transceiver. This wireless access point may be referred to as an 802.11 base station. Such wireless connections are described in the text, iPod™+iTunes™ for Windows™ and Mac™ in a Snap, Brian Tiemann, Sams Publishing, Indianapolis, Ind., 2006, at pp. 228-231.

The advanced enabling of the above-described short range wireless connections has been facilitated by the development of the industry standard IEEE 802.11 through the most current 802.15.1 (Bluetooth) short range RF protocols. The IEEE 802.11 through 802.15 wireless transmission protocols are discussed in greater detail at pp. 60-62 in the text, Peter Norton's Complete Guide to Networking, SAMS Division of MacMillan Computer Publishing, Indianapolis, Ind., 1999, pp. 49-62, as well as in the article, A Wireless Local Area Network Protocol That Improves Throughput Via Adaptive Control, B. E. Mullins et al., Proceedings of the IEEE International Conference on Communications, pp. 1427-1431, June 1997. The short range transmissions can operate within facility areas of from 10 to 100 meters in diameter from a central or optimally located facility transceiver.

As a result of these wireless technology advances, facilities within which wireless communication and entertainment devices may be used have become pervasive within our society. This situation has been recognized to have presented social issues of individuals moving through a social landscape with a variety of headsets and earpieces, and isolated from social contacts through such ear covering implementations. However, even more significant than this potential social isolation, is the potential for shutting out of users of wireless devices from the external auditory alarms such as whistles, sirens, horns and bells normally used to warn the public of dangerous and even life-threatening situations.

### SUMMARY OF THE PRESENT INVENTION

The present invention recognizes the danger of unrecognized external alarms to users of wireless devices, and seeks to provide an implementation that enables users of wireless devices with appropriate alerts responsive to such alarms.

The invention is directed to conventional short range RF networks for transmitting to a plurality of wireless RF transceiving devices within a defined area. The wireless devices within the defined area each include a short range RF device transceiver enabling the device to wirelessly communicate with a data processor controlled wireless transmission system within said defined area including a centrally located short range RF system transceiver for transmitting data to the wireless devices. For optimum efficiency, the central system transceiver should have an RF transmission range covering the defined area. In situations where the facility area is larger than the transmission range of a single RF transceiver, the facility area may be divided into a plurality of sub-areas, each having a central transceiver with a RF range covering its sub-area. The invention provides for an implementation for detecting an external alarm within said defined area and for transmitting the alarm to the wireless devices through the system central transceiver.

The invention is intended to be most effective where the facility includes a plurality of users listening to output from personal wireless devices with ear masking output expedients, e.g. headsets or ear pieces.

In the short range RF wireless transmission systems to which the invention is directed that operate under IEEE 802.11-802.15 protocols, it is customary to assign a channel or channel set within the RF Band appropriated under the protocols to each operational transmission to a wireless device within the area. In such an environment, the present invention may be implemented by dedicating a channel or channel set to be used only for alarms. Then if an external alarm is sensed, all transmissions along other channels in the transmission area may be overridden, and the alarm data broadcast over the dedicated channel to all operational wireless devices within the area.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a generalized diagrammatic view of an illustrative short range RF network of wireless devices within a facility area with an alarm system in accordance with the present invention;

FIG. 2 is a block diagram of a data processing system including a central processing unit and network connections via a communications adapter that functions as the data processor controlled wireless central transceiver for transmitting to the wireless devices within the defined facility area;

FIG. 3 is an illustrative flowchart describing the setting up of the programming functions to form the implementation for dynamically transmitting external alarms to wireless devices within a defined RF wireless transmission area; and

FIG. 4 is a flowchart of an illustrative run of the program set up according to FIG. 3.

### DETAILED DESCRIPTION OF THE PREFERRED EMBODIMENT

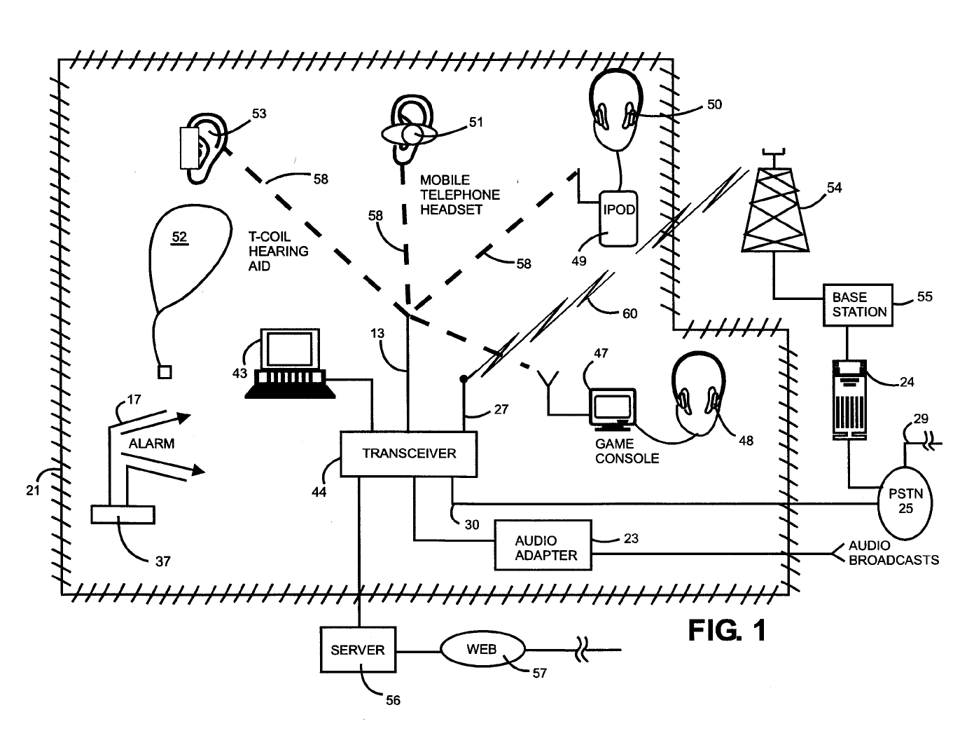

Referring to FIG. 1, there is a generalized example of a defined facility marked by hashed boundary 21. For simplification in illustration, let us assume that the facility within boundary 21 is a household. It could, of course, be an office, manufacturing plant, school or store. The defined facility could even be a motor vehicle, such as a motor home or just a passenger automobile in which a passenger could be involved in “hands-free” audio conversations involving wireless RF short range transmissions that are ear masking. For example, drivers of automobiles who have masked ears, might not hear the external alarms of emergency vehicles. The motor vehicles could be set up with the described external alarm sensors.

The wireless communications to be described will be between a central or optimally located transceiver 44 under the control of computer 43. Transceiver 44 transmits wirelessly 58 to several wireless devices, to be subsequently described, within household 21. While the alarm system of this invention will operate effectively in any defined wireless device communication area, in the present embodiment, we will use the standard IEEE 802.11 through the most current 802.15.1 (Bluetooth) short range RF protocols. The IEEE 802.11 through 802.15 wireless transmission protocols are discussed in greater detail at pp. 60-62 in the text, Peter Norton's Complete Guide to Networking, SAMS Division of MacMillan Computer Publishing, Indianapolis, Ind., 1999, pp. 49-62, as well as in the article, A Wireless Local Area Network Protocol That Improves Throughput Via Adaptive Control, B. E. Mullins et al., Proceedings of the IEEE International Conference on Communications, pp. 1427-1431, June 1997. The short range transmissions can operate within facility areas of from 10 to 100 meters in diameter from a central or optimally located facility transceiver.

While the illustration uses only one central transceiver 44, the RF transmission range of this transceiver should optimally cover the entire area within facility 21. Should the area of a facility supporting wireless communication exceed the RF communication range of the central transceiver 44, the industry will use a plurality of optimally spaced transceivers having overlapping RF communication ranges so as to cover the entire area of a facility.

The computer 43 controlled central transceiver 44 serves as the wireless communication hub for a variety of wireless devices within boundary 21. With respect to telephone communications, a wireless cellular telephone within facility 21, can communicate directly with the closest cellular tower 54. However, for other purposes, it may be advantageous to have a cellular telephonic input 60 from cellular tower 54 to the central transceiver 44 via antenna 27. Of course, there may also be a wired telephone input 30 to transceiver 44 from more remote appropriate cellular towers 54 via base stations 55 through appropriate switching networks 24 connected to PSTN (Public Switching Telephone Networks) 25 that also have other wired telephone inputs 29. Among the other inputs to computer 43/transceiver 44 are audio broadcasts, including television network broadcasts and cable TV inputs via audio adapter 23; and Internet, i.e. Web 57 access via server 56. Such access would include e-mail. For e-mail and other transactions this network input could be from other public and private networks. All these inputs to transceivers may be selectively distributed under the control of computer 43 through the IEEE 802.15 RF wireless transmissions 58 to requesting wireless devices (each having an RF transceiver) such as MP3 player, e.g. IPod™ 49, mobile wireless telephone headset 51 or game console 47.

By way of background, the illustrative Bluetooth wireless transmission protocol is assigned a free band at 2.45 Ghz. For the wireless transmissions within the facility, the protocol divides the assigned band into about 79 channels (each one MHz wide). Thus, when any of the described wireless devices wishes to connect to the central transceiver 44 to access any of the inputs to the central transceiver, the device transceiver requests access and the computer 43 controlling the central transceiver assigns a set of one or more of the 79 channels for the wireless connection with the central transceiver. The appropriate requested input source is, thus, wirelessly connected to the requesting wireless device. Under such an operational condition, it is often the case that the ears of the users are covered and, thus, masked to external sounds. For example, with game console 47 the ears of the user may be covered with headset 48 and with the Ipod™ MP3 player 49, the ears of the user may be covered with headset 50. Also mobile telephones are made hands free with appropriate headsets or ear pieces 51.

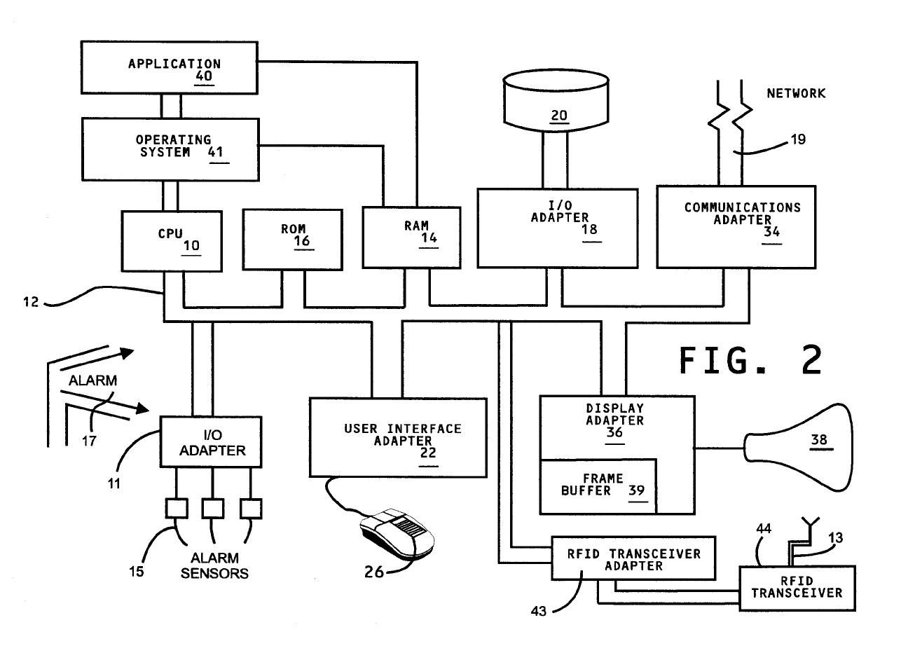

The present invention relates to circumstances within the facility 21 wherein at least a few of the ears of the users of the wireless devices are masked, as shown by the ear pieces or headsets, and an external alarm 17 from a source 37 is sounded. As will be hereinafter described in greater detail with respect to FIGS. 2 through 4, the implementation of the present invention will override all wireless RF transmissions 58 between central transceiver 44 and the transceivers in the wireless devices, and will broadcast an alarm between the central transceiver 44 and the device transceivers. For best results, one or a set of the 79 available channels may be dedicated for alarm purposes, and the alarm broadcast over the dedicated channel or channels.

It should be noted that the same Bluetooth wireless protocols are used in certain hearing aid devices, such as the T-Coil hearing aids 52 wherein the spoken sounds are picked up by a loop or coil worn around the user's neck and transmitted through IEEE 802.15 protocols to an ear piece worn in the user's ear 53. In addition to the hearing aid device shown, there are hearing aids in which the hearing aid ear piece could include the actual tranceiver. Irrespective of the structure of the hearing aid, if such a device is in use within facility 21, the alarm may still be RF broadcast to the hearing aid device via the alarm notification channels from central transceiver 44.

Referring now to FIG. 2, a typical generalized data processing system display terminal is shown that may function as the central data processing system 11 of this invention. A central processing unit (CPU) 10, such as any PC microprocessor in a PC available from International Business Machines Corporation (IBM) or Dell Corp., is provided and interconnected to various other components by system bus 12. An operating system 41 runs on CPU 10, provides control and is used to coordinate the functions of the various components of FIG. 1. Operating system 41 may be one of the commercially available operating systems, such as Microsoft's Windows XP™, as well as the UNIX or IBM AIX operating systems. An application program that includes routines of the present invention for dynamically transmitting external alarms to the mobile wireless personal digital devices to be subsequently described in detail, runs in conjunction with operating system 41 and provides output calls to the operating system 41, which, in turn, implements the various functions to be performed by the application 40. A Read Only Memory (ROM) 16 is connected to CPU 10 via bus 12 and includes the Basic Input/Output System (BIOS) that controls the basic computer functions. Random Access Memory (RAM) 14, I/O adapter 18 and communications adapter 34 are also interconnected to system bus 12. It should be noted that software components, including operating system 41 and application 40, are loaded into RAM 14, which is the computer system's main memory. I/O adapter 18 may be a Small Computer System Interface (SCSI) adapter that communicates with the disk storage device 20. Communications adapter 34 interconnects bus 12 with an outside network linkage 34 to communicate with other such systems over a network and includes, of course, the Internet or Web. I/O devices are also connected to system bus 12 via user interface adapter 22 and display adapter 36. Keyboard 24 and mouse 26 are all interconnected to bus 12 through user interface adapter 22. Mouse 26 operates in a conventional manner insofar as user movement is concerned. There is a display associated with the controlling computer or server. In such a set up, display adapter 36 includes a frame buffer 39 that is a storage device that holds a representation of each pixel on the display screen 38. Images may be stored in frame buffer 39 for display on monitor 38 through various components, such as a digital to analog converter (not shown) and the like. By using the mouse or related devices, a user is capable of inputting information to the system through the keyboard 24 or mouse 26 and receiving output information from the system via display 38. The system controls central RF transceiver 44 through RF transceiver adapter 43. Transceiver 44 transmits via RF channels via antenna 13 to the receiving wireless devices shown in FIG. 1. When an external alarm 17 is sounded, it is sensed by sound sensitive alarm sensors 15 connected via the I/O adapter to CPU 10, which, in turn, conveys the alarm to central transceiver 44 that transmits the alarm through RF transmissions. The transmitted alarm data could be brought to the wireless device user's attention as an audio alert, and also as a displayed alarm in cases where the wireless device has a display. Where the wireless devices have extensive accessing of the Web for transactions, Web mail, IP telephoning, game playing and MP3 input, the alarm sent from the central transceiver to the wireless device transceivers could be in the form of an audio XML (Extensible Markup Language) file containing the alarm message to be played on the users' devices. This XML file could be stored on the computer storage drive 20 until the external alarm activation, as described above.

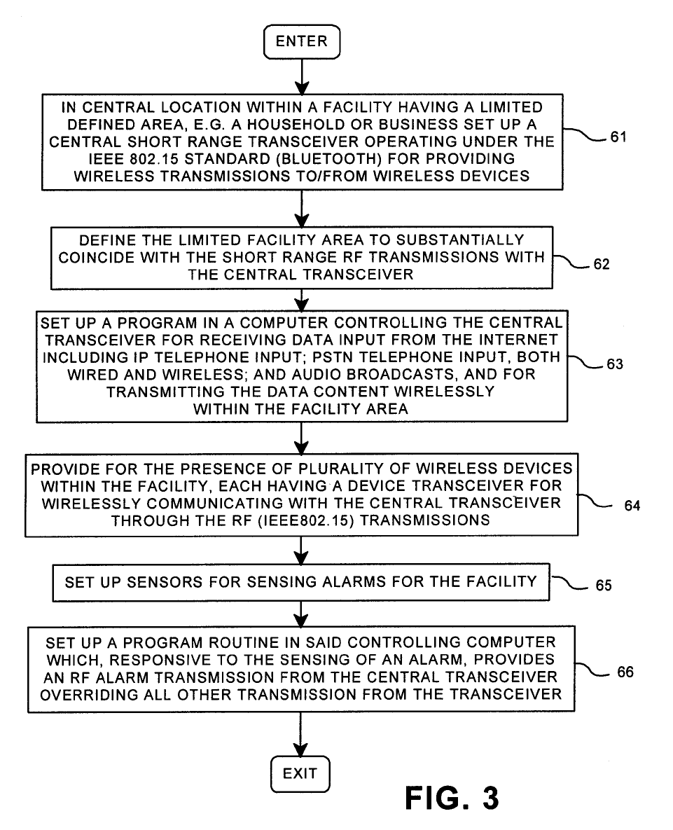

Now, with reference to the programming shown in FIG. 3, there will be described how the system and programs of the present invention are set up. In a central location within a facility having a limited defined area, there is set up a central short range RF transceiver operating the IEEE 805.15 (Bluetooth) standard, for providing wireless transmission to and from wireless devices with RF transceivers within the defined area, step 61. The defined area is limited to substantially coincide with the limits of the short range transmissions with the central transceiver, step 62, e.g. ranges within a radius of from 10 to 100 meters that are dependent on the central transceiver and the facility. For larger facilities, several optimally spaced central transceivers may be used. There is set up in the computer controlling the central transceivers a program including routines for receiving standard data input from a variety of sources: the Web, including IP telephone input, conventional PSTN telephone input, audio network and cable broadcasts including television; as well as for distributing the received data content through RF wireless transmissions within the defined area of the facility, step 63. Provision is made for the presence of a plurality of wireless devices within the facility, with each device having a transceiver for communicating through RF wireless transmissions with the central transceiver under the IEEE 802.15 (Bluetooth) Protocols, step 64.

It should be understood that the commonly used Bluetooth protocols have only been selected as an example. The alarm system of this invention would be operational with any system using short range wireless transmissions within a limited area facility.

Sensors are set up for sensing external alarms, i.e. alarms from sources outside of the wireless transmission system, step 65. A routine is set up in the controlling computer that, responsive to the sensing of an alarm, broadcasts an RF alarm transmission from the central transceiver to all transceivers in wireless devices within the transmission range that overrides all other transmissions between the central transceiver and the wireless devices, step 66.

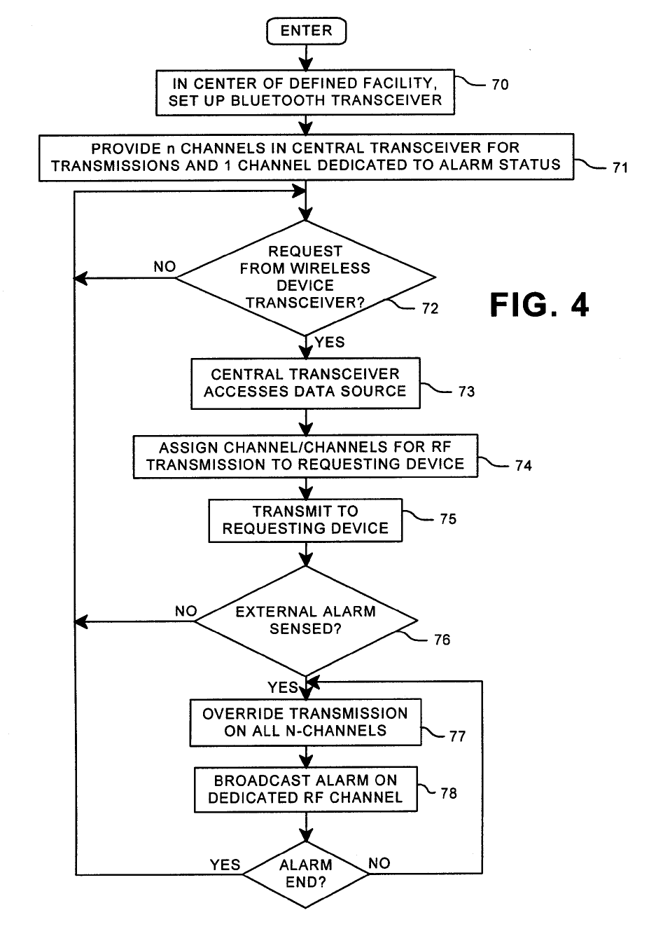

Now, with reference to the flowchart of FIG. 4, a simplified illustrative run of the process set up in FIG. 3 will be described. The simplification is made so as to illustrate an understandable process. In the center of the defined facility, a transceiver transmitting under the IEEE 802.15 protocols is set up, step 70. There is set up for the central transceiver to have n different frequency channels for assignment for RF wireless transmissions individually or in sets for communications between the central transceiver and respective wireless devices within the facility. Also, there is dedicated one of a set of channels for transmitting the alarm, step 71. Then, during the conventional operation, determinations are made, step 72, as to whether wireless device transceivers within the facility have requested data from a source. If Yes, the computer controlling the central transceiver accesses the data from the source, step 73, and assigns a channel or channel set to the requesting device, step 74. RF transmission of the data accessed from the source is commenced from the central transceiver to the requesting device over the assigned channels, step 75. An external alarm is continuously sensed for, step 76. If there is a Yes determination that there is an external alarm sensed, transmissions on all of the assigned n channels are overridden, step 77, and the alarm is broadcast to all devices within the transmission range of the central transceiver on the dedicated alarm channel(s), step 78. During this alarm state, a determination is continually made as to whether the external alarm is ended, step 79. If No, the process is branched to step 77 and the alarm transmission state and broadcast is continued. If Yes, the external alarm is ended, then the process is branched back to step 72, where the normal transmission conditions are resumed and the next request from a wireless device within the facility is awaited.

The normal transmission override function need not turn off the normal audio transmission when an alarm is sounded. There may be implementations in which the normal audio stream is continued and merely reduced in volume so that it is still sufficient to allow the alarm to be clearly audible.

Although certain preferred embodiments have been shown and described, it will be understood that many changes and modifications may be made therein without departing from the scope and intent of the appended claims.

What is claimed is:

1. In a wireless short range RF network comprising a plurality of wireless RF transceiving devices within a defined area, a system for dynamically transmitting alarms to said devices comprising:
at least one wireless device within said defined area including a short range RF device transceiver;
a data processor controlled wireless transmission system within said defined area including;
a short range RF system transceiver for transmitting data to said wireless device;
means for detecting an alarm within said defined area; and
means for transmitting said alarm to said at least one wireless device by said system transceiver.

2. The system of claim 1 wherein said short range RF system transceiver has a transmission range covering said defined area.

3. The system of claim 1 wherein said at least one wireless device has an ear masking output.

4. The system of claim 3 including a plurality of said devices within said defined area, each device including a short range RF device transceiver.

5. The system of claim 4 wherein said means for transmitting said alarm broadcasts said alarm to said plurality of devices.

6. The system of claim 5 wherein said means for transmitting said alarm broadcasts said alarm to all devices within said defined area having short range RF transceivers.

7. The system of claim 6 wherein:
each of said devices within said defined area has at least one RF channel assigned for said RF transmissions, and at least one additional universal RF channel dedicated for transmitting said alarm to said wireless device; and
means for transmitting broadcasts said alarm on said dedicated channel.

8. The system of claim 4 wherein said data processor controlled wireless transmission system further includes means for overriding transmissions to said wireless devices with said transmitted alarm.

9. The system of claim 3 wherein said device is a user hearing aid including:
an audio amplifier; and
said short range RF device transceiver.

10. The system of claim 3 wherein said defined area is the whole area of a motor vehicle.

11. A computer controlled method for dynamically transmitting alarms to a plurality of wireless RF transceiving devices within a defined area in a wireless short range RF network comprising:
transmitting data to at least one of said wireless transceiving devices via short range RF transmission;
detecting an alarm within said defined area; and
transmitting said alarm to said at least one wireless device transceiver.

12. The method of claim 11 wherein said short range RF transmission has a transmission range covering said defined area.

13. The method of claim 11 wherein said at least one wireless device has an ear masking output.

14. The method of claim 13 wherein said data is transmitted to a plurality of said wireless transceiving devices via short range RF transmission.

15. The system of claim 14 wherein said step of transmitting said alarm broadcasts said alarm to said plurality of devices.

16. The method of claim 15 wherein said step of transmitting said alarm broadcasts said alarm to all devices within said defined area having short range RF transceivers.

17. The method of claim 16 further including the steps of:
assigning to each of said devices within said defined area at least one RF channel for said RF transmissions, and dedicating at least one additional universal RF channel for transmitting said alarm to said wireless device; and
broadcasting said alarm on said dedicated channel.

18. The method of claim 14 further including the step of overriding transmissions to said wireless devices with said transmitted alarm.

19. A computer program having code recorded on a computer readable storage medium for dynamically transmitting alarms to a plurality of wireless RF transceiving devices within a defined area in a wireless short range RF network comprising:
means for transmitting data to at least one of said wireless transceiving devices via short range RF transmission;
means for detecting an alarm within said defined area; and
means for transmitting said alarm to said at least one wireless device transceiver.

20. The computer program of claim 19 wherein said means for transmitting said alarm broadcasts said alarm to all devices within said defined area having short range RF transceivers.

21. The computer program of claim 19 further including means for overriding transmissions to said wireless devices with said transmitted alarm.
